(19) United States
(12) Patent Application Publication
(10) Pub. No.: US 2020/0231081 A1
(43) Pub. Date: Jul. 23, 2020

(54) MOBILE LABORATORY AND METHOD TO EXPEDITE REGULATORY TEST RESULTS FOR AGRICULTURAL, FOOD, AND/OR BEVERAGE PRODUCTS

(71) Applicant: Gregory A. Coons, San Diego, CA (US)

(72) Inventor: Gregory A. Coons, San Diego, CA (US)

(21) Appl. No.: 16/746,265

(22) Filed: Jan. 17, 2020

Related U.S. Application Data
(60) Provisional application No. 62/793,775, filed on Jan. 17, 2019.

(51) Int. Cl. B60P 3/00; G01N 30/72; B01L 9/00; B60R 16/03; G01N 30/02

(52) U.S. Cl. CPC B60P 3/00; G01N 30/7233; G01N 30/7206; G01N 2030/025; B60R 16/03; G01N 2030/027; B01L 9/00

(57) ABSTRACT

A mobile laboratory and method to expedite regulatory test results for agricultural food and/or beverage products. The mobile laboratory can include test equipment mounted on shock absorbing and leveling stands that are disposed in a truck or in a trailer. The mobile laboratory can be taken directly to a customer's location and tests performed on samples at that location, thus avoiding the time and expense of the customer packaging and shipping samples to a non-mobile lab, thus providing the ability to deliver test results directly to the customer much more quickly. The mobile laboratory can include one or more gas chromatography, mass spectroscopy, and/or liquid chromatography systems.

### CROSS-REFERENCE TO RELATED APPLICATIONS

This application claims priority to and the benefit of the filing of U.S. Provisional Patent Application No. 62/793,775, entitled “Mobile Laboratory and Method to Expedite Regulatory Test Results for Agricultural. Food, and Beverage Products”, filed on Jan. 17, 2019, and the specification thereof is incorporated herein by reference.

### BACKGROUND OF THE INVENTION

Embodiments of the present invention relate to safety and quality food testing, and more particularly, to on-site regulatory testing of crops.

U.S. Federal and State regulations require testing of agricultural products to ensure that the food supply is safe. There are, for example, well established benchmark levels for acceptable pesticide residues. This ensures that, for example, fruits, vegetables, grains, rice, tobacco, specialty products, bottled drinking water and other commodities remain at safe levels for pesticide residues and other contaminants, which helps to avoid adverse health effects of consumers. In some instances, state agencies, rather than the U.S. Federal Government, mandate stricter safety and quality testing such as for heavy metals, residual solvents, etc., for certain products. In California, for example, new regulations for cannabis products require testing for approximately 110 potential contaminants and pesticides, terpenoids, heavy metals, mycotoxins, potency, and other quality standards. To meet these requirements, farmers/growers must send samples of product batches to remote laboratory facilities for testing, where cross contamination and/or sample degradation issues often cause the entire batch being tested to be destroyed. This current testing landscape generally results in at least 20% of lost product. There is a long-felt, but unmet need for on-site safety and quality testing for products. Embodiments of the present invention provide systems and methods for on-site testing of products such as cannabis for various mandated assessments including, but not limited to, heavy metals, residual solvents, pesticides, terpenes, and potency.

### BRIEF SUMMARY OF EMBODIMENTS OF THE PRESENT INVENTION

Embodiments of the present invention relate to a mobile laboratory that includes a vehicle, a power supply, one or more work stations, one or more suspension system platforms, the one or more suspension system platforms comprising a plurality of dampers and a plurality of gimbals, a plurality of test systems, and at least one of the plurality of test systems disposed in the one or more suspension system platforms. Optionally, the plurality of test systems can include at least a gas chromatography system and a mass spectroscopy system, and/or at least a gas chromatography system, a liquid chromatography system, and a mass spectroscopy system. The vehicle can include a self-propelled vehicle and/or a trailer. Optionally, the one or more suspension system platforms also include a floating attachment tray disposed on or otherwise connected to the plurality of dampers. The one or more suspension system platforms can also include at least one equipment holding bracket, which can be connected to the plurality of gimbals. In one embodiment, at least one of the plurality of test systems that are disposed in the one or more suspension system platforms can rest atop the floating attachment tray and can be secured to the equipment holding bracket. Optionally, the power supply can include a generator. In one embodiment, the power supply need not be physically disposed in the vehicle, rather, desirable results can be obtained when power is provided to the vehicle from a power system that is remote from the trailer.

Embodiments of the present invention also relate to a method for providing a mobile laboratory including providing a vehicle, providing a plurality of test systems, and mounting at least one of the test systems in the vehicle in a suspension platform such that the at least one test system is held at least substantially level when the vehicle rocks or sways. Optionally, mounting at least one of the test systems in the vehicle in a suspension platform can include mounting at least one of the test systems in the vehicle in a suspension platform such that the at least one test system is at least partially isolated from vertical shock experienced by the vehicle. Mounting at least one of the test systems in the vehicle in a suspension platform can include mounting a liquid chromatography system in a suspension platform. Optionally, providing a plurality of test systems can include providing at least a gas chromatography system and a mass spectroscopy system. Optionally, providing a plurality of test systems can include providing at least a gas chromatography system, a liquid chromatography system, and a mass spectroscopy system. In one embodiment, mounting at least one of the test systems in the vehicle in a suspension platform can include placing the at least one test system on a floating attachment tray that provides shock absorption. Optionally, mounting at least one of the test systems in the vehicle in a suspension platform can include attaching the at least one test system to a holding bracket which is supported by a plurality of gimbals. Providing a vehicle can include providing a self-propelled vehicle and/or a trailer. The method can also include securing the suspension platform to a benchtop.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a perspective outside view of an embodiment of a mobile laboratory embodiment;

FIG. 2 is a drawing which illustrates a layout of an interior space of a mobile laboratory according to an embodiment of the present invention;

FIG. 3 is a side view of an embodiment of a suspension tray system for holding equipment;

FIG. 4 is a front view of the embodiment of FIG. 3;

FIG. 5 is a drawing which illustrates a side-view of an embodiment of a mobile laboratory according to an embodiment of the present invention;

FIG. 6 is a drawing which illustrates a top view wherein a portion of the enclosure of the mobile laboratory has been removed to show placement of a generator therein; and

FIG. 7 is a drawing which illustrates a layout of an interior space of a mobile laboratory according to an embodiment of the present invention.

### DETAILED DESCRIPTION OF THE INVENTION

In the following detailed description, numerous specific details are set forth in order to provide a thorough understanding of the embodiments of the invention. However, upon studying this application, it will be understood by one of ordinary skill in the art that the embodiments may be practiced without these specific details. For instance, well known operation or techniques may not be shown in detail.

Currently, a conventional static laboratory receives samples that have undergone multiple transfers from when the material batch was originally sampled to the time it was delivered to the laboratory for work up. This increases the opportunity for samples to become mishandled, cross contaminated, lost or improperly allocated to another batch of samples. Additionally, sample transfers are subjected to temperature changes that imperil the integrity of the sample via degradation, increased mold growth and other toxin producing circumstances.

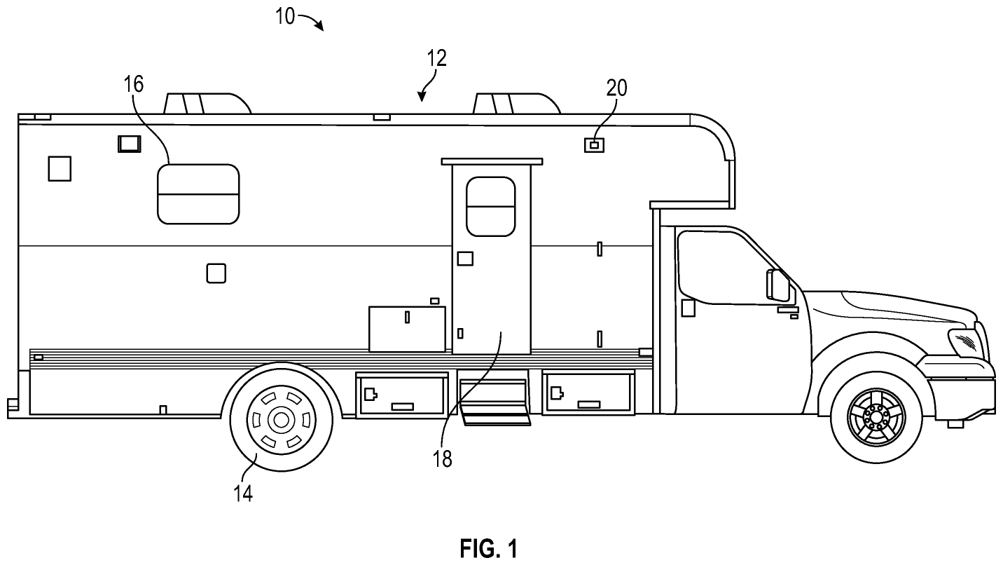

Cross contamination and/or sample degradation are avoided with embodiments of the present invention. Embodiments of the present invention provide systems and methods for on-site testing of products such as cannabis for various mandated assessments including, but not limited to, heavy metals, residual solvents, pesticides residues and other contaminants, mycotoxins, terpenes, potency and other quality standards. Referring to the figures, in one embodiment, mobile lab system 10 comprises mobile laboratory 12. In one embodiment, mobile laboratory 12 can be approved as meeting the operational standards required by federal (“FDA”) and State of California inspectors (e.g., Bureau of Cannabis Control). Referring to FIG. 1, in one embodiment, a camper trailer, recreational vehicle (“RV”) motorhome vehicle, box truck, or other vehicle or trailer having an adequate size to house the items described herein is adapted to or otherwise provided for the construction mobile laboratory 12, and preferably meets all of the operational and safety requirements for travel on roads and highways and most preferably includes wheels 14, one or more windows 16, one or more doors 18, and one or more lights 20. As used throughout this application, the term “vehicle” is intended to include not only trucks, automobiles or other self-propelled mobile devices, but also non-self-propelled mobile structures, including trailers. Preferably, mobile laboratory 12 is insulated and further comprises running water, electricity, climate controls for heating and cooling, communication capability, on-board waste controls and on-line security cameras.

In one embodiment, the interior of mobile laboratory 12 preferably includes one or more working stations with equipment in a broad spectrum of environmental and forensic/toxicology analyses—most preferably including but not limited to one or more of, gas chromatography (“GC”), mass spectroscopy (“MS”), liquid chromatography (“LC”), deoxyribonucleic acid (“DNA”) sequencing, combinations thereof, and the like. Preferably, the testing equipment is adaptable to various regulatory requirements for detection levels, compounds of interest, expediency, error margins, combinations thereof, and the like.

In one embodiment, mobile laboratory 12 is preferably equipped to operate using one or more of the following sources of power: 1) a direct source of onsite electric power (e.g., an AC land-line source connected via an extension cord); 2) battery power (e.g., the mobile laboratory embodiment can include an AC-DC inverter that allows batteries to power the equipment, and an external AC source, for example 110 volt plug-in, to recharge the batteries); 3) one or more diesel, propane, and/or gasoline generators 11 of suitable power; 4) a solar power station that converts solar energy to electricity; and/or a combination thereof. In one embodiment, batteries are stored, for example, in a compartment. In one embodiment, an inverter allows recharging of the batteries. In one embodiment, the electrical systems in mobile laboratory 12 are controlled by an internally wired distribution system that allows the power to be switched from source to source and stepped up or down as needed for the respective equipment's needs, and for the non-battery sources to recharge the batteries. Preferably, an electrical current that is virtually free from voltage and/or current spikes—most preferably virtually free from even minor amperage and voltage spikes, is maintained at each working station while analytical equipment is being used to produce error free and reliable results.

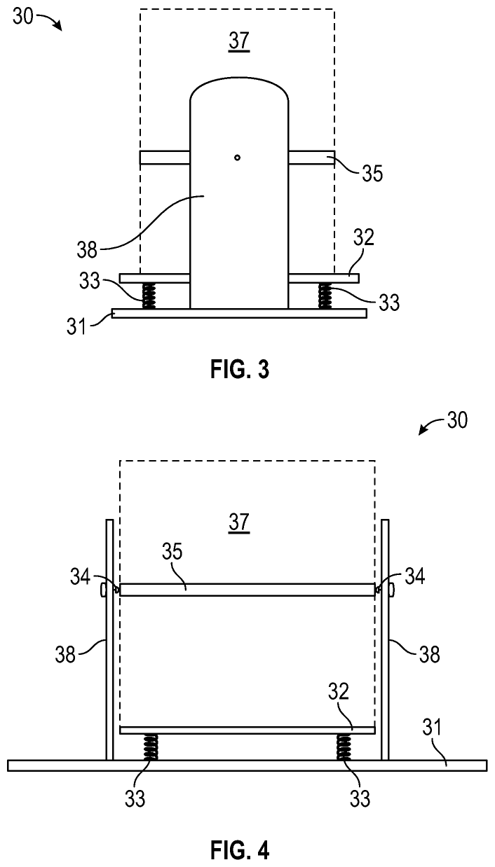

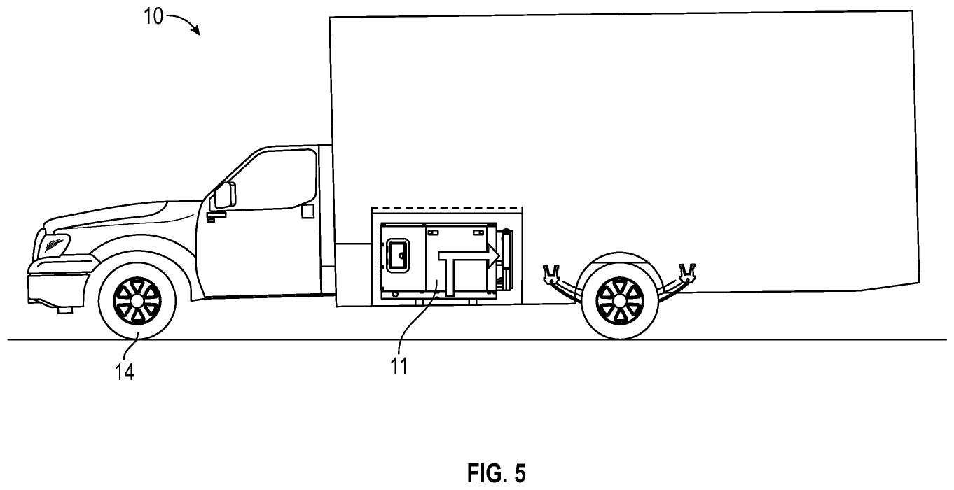

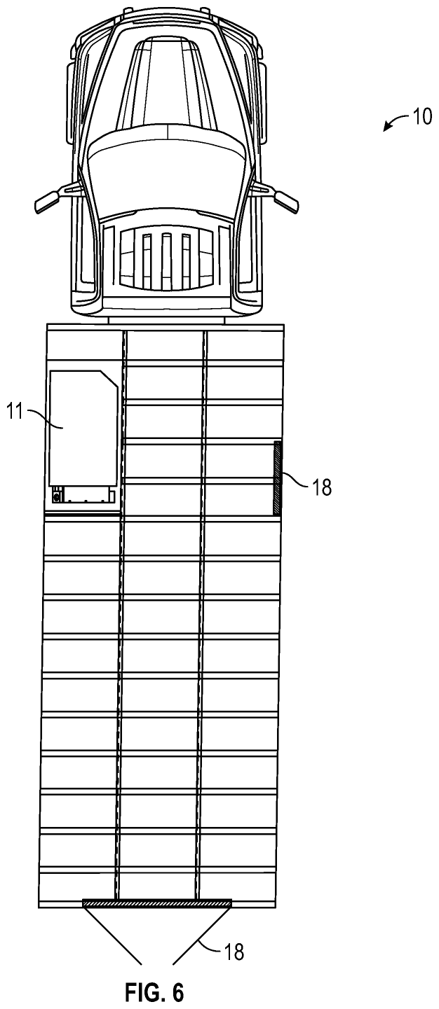

As best illustrated in FIGS. 3 and/or 4, because of the relative sensitivity of the equipment needed to conduct, for example, liquid chromatography, in one embodiment of the invention, at least some of the machines are preferably installed on one or more suspension system platforms 30 that are secured to mounting surface 31 which can include a benchtop, floor or other mounting platform for the various stations and preferably include floating attachment trays 32 connected to or otherwise disposed on a plurality of dampers 33. In one embodiment, holding brackets 35 secure a piece of equipment 37 and are connected by a plurality of gimbals 34 and support columns 38. In one embodiment, system platforms 30 are augmented by shock absorbing engineering controls that reduce vertical insult and recapture destructive momentum due to vertical insult caused by roadway irregularities, and that can preferably support up to 300 pounds or more of equipment. In one embodiment, this can include engineered vibration mats that are disposed beneath mounting connections, floating suspension equipment tables that absorb vertical shock or displacement, and engineered Air-Ride suspension systems that can be installed at a location between each axle and the payload. As such, the equipment preferably remains at least substantially level and substantially shock-free while mobile laboratory 12 is in transit, because attachment trays 32 absorb motion from road bumps and turns while gimbals 34 help keep equipment 37 level.

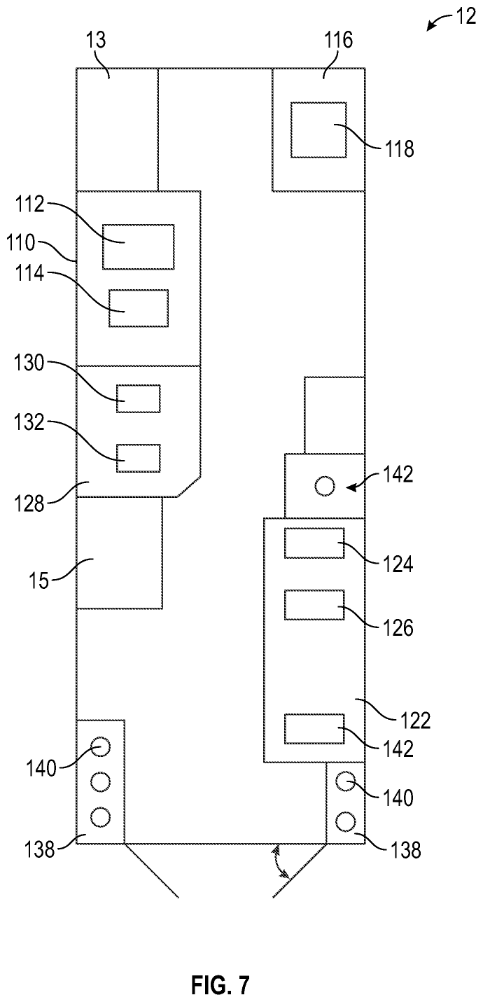

In one embodiment, one or more working stations comprise one or more operating bio-hood/clean benches comprising an internally exhausted high-efficiency particulate air (“HEPA”) filtered arrangement. In one embodiment, mobile laboratory 12 comprises one or more externally exhausted HEPA hoods. Preferably, the internal operational theater of mobile laboratory 12 creates a clean room environment. The need for fresh air is preferably accommodated by acquiring replacement air through a ventilator that contains one or more HEPA filters for particles and one or more carbon filters for organic vapors. In one embodiment a plurality of hoods can be provided. For example, as illustrated in FIG. 7, a first hood 13 can be provided at a first location and a second hood 15 can be provided at a second location. Optionally, one or both of hoods 13 and 15 can be externally and/or internally vented (for example, while using a HEPA filter and/or an activated charcoal filter).

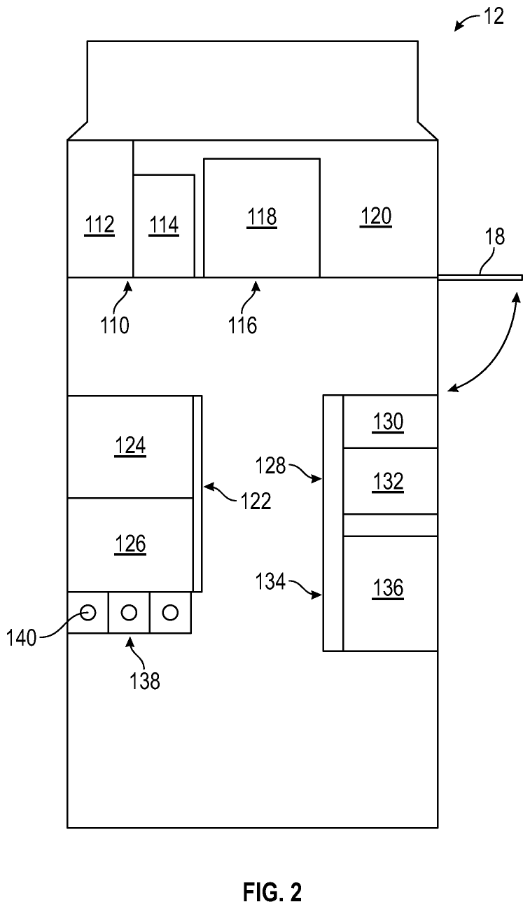

Referring to FIGS. 2 and 7, in one embodiment, a first working station 110 is preferably configured for pesticide testing via, for example, GC and/or MS system 112, which can include for example, a THERMO SCIENTIFIC® TSQ 9000 system, for GC-MS (THERMO SCIENTIFIC® is a registered trademark of Thermo Fisher Scientific Inc.). In one embodiment, station 110 preferably further comprises GC system 114, which can include for example, a THERMO SCIENTIFIC® TRACE 1310 GC system.

In one embodiment, second working station 116 is preferably provided and is most preferably configured for heavy metals testing unit 118, which can optionally include a unit which performs microwave digestion of samples followed by MS, which can include for example, a THERMO SCIENTIFIC® iCAP RQ system for multi-element analysis. Optionally, a solvent mixing system 120, which can include for example, a THERMO SCIENTIFIC® Vanquish Flex Quaternary solvent blending system, is preferably provided, most preferably at or near working station 116. Optionally, however, second working station 116 can include heavy metals testing unit 118 while solvent mixing system 120 can instead be provided on third working station 122.

In one embodiment, third working station 122 is preferably provided and is most preferably configured for pesticide testing via system 124, which is most preferably an LC and MS system and can include, for example, a THERMO SCIENTIFIC® TSQ Altis Triple Quadrupole Mass Spectroscopy system, and a high performance or ultra high-performance liquid chromatograph system (‘UHPLC’) 126, which can include for example, a THERMO SCIENTIFIC® Vanquish Flex UHPLC system.

In one embodiment, fourth working station 128 is configured for testing of residual solvents and terpenes via GC and MS system 130, which can include, for example, a THERMO SCIENTIFIC® ISQ 7000 Single Quadrupole GC-MS system, and fourth working station 128 preferably includes GC system 132, which can include, for example, a THERMO SCIENTIFIC® TRACE 1310 GC system. Although fourth working station 128 can be provided in a location away from first working station, optionally, fourth working station 128 can be adjacent to or otherwise grouped together with first working station 110, or any other working station. Thus, first working station 110 and fourth working station 128 need not be physically delineated from one another. Likewise, all or some subset of work stations 110, 116, 122, and/or 128 can optionally be provided adjacent to one another or otherwise incorporated into a single work station or group of work stations. Desirable results can be obtained even when no physical delineation is provided between any two or more of work stations 110, 116, 122, and/or 128.

In one embodiment, fifth working station 134 can be provided and is preferably configured for testing the potency of samples, for example, cannabinoid samples, via LC system 136, which can include, for example, THERMO SCIENTIFIC® Vanquish Flex UHPLC system.

One or more storage areas 138 can optionally be provided and are most preferably configured to store one or more gas bottles 140. Of course, any desired gas can be stored in any of gas bottles 140, but in one embodiment, gas bottles 140 preferably respectively store Argon, Helium, or Nitrogen. In one embodiment, nitrogen generator 142 can be provided.

Although specific reference has been made to mobile testing of cannabis products, the invention is useful for testing of other products, including but not limited to: crops, fruits, vegetables, grains, tobacco, water, beverages, food, and agricultural commodities.

Note that in the specification and claims, “about” or “approximately” means within twenty percent (20%) of the numerical amount cited.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A mobile laboratory comprising:
a vehicle;
a power supply;
one or more work stations;
one or more suspension system platforms; said one or more suspension system platforms comprising a plurality of dampers and a plurality of gimbals;
a plurality of test systems; and
at least one of said plurality of test systems disposed in said one or more suspension system platforms.

2. The mobile laboratory of claim 1 wherein said plurality of test systems comprise at least a gas chromatography system and a mass spectroscopy system.

3. The mobile laboratory of claim 1 wherein said plurality of test systems comprise at least a gas chromatography system, a liquid chromatography system, and a mass spectroscopy system.

4. The mobile laboratory of claim 1 wherein said vehicle comprises a self-propelled vehicle.

5. The mobile laboratory of claim 1 wherein said vehicle comprises a trailer.

6. The mobile laboratory of claim 1 wherein said one or more suspension system platforms further comprise a floating attachment tray disposed on or otherwise connected to said plurality of dampers.

7. The mobile laboratory of claim 6 wherein said one or more suspension system platforms further comprise at least one equipment holding bracket.

8. The mobile laboratory of claim 7 wherein said at least one equipment holding bracket is connected to said plurality of gimbals.

9. The mobile laboratory of claim 8 wherein said at least one of said plurality of test systems that are disposed in said one or more suspension system platforms rest atop said floating attachment tray and are secured to said equipment holding bracket.

10. The mobile laboratory of claim 1 wherein said power supply comprises a generator.

11. A method for providing a mobile laboratory comprising:
providing a vehicle;
providing a plurality of test systems; and
mounting at least one of the test systems in the vehicle in a suspension platform such that the at least one test system is held at least substantially level when the vehicle rocks or sways.

12. The method of providing a mobile laboratory of claim 11 wherein mounting at least one of the test systems in the vehicle in a suspension platform further comprises mounting at least one of the test systems in the vehicle in a suspension platform such that the at least one test system is at least partially isolated from vertical shock experienced by the vehicle.

13. The method of providing a mobile laboratory of claim 11 wherein mounting at least one of the test systems in the vehicle in a suspension platform comprises mounting a liquid chromatography system in a suspension platform.

14. The method of providing a mobile laboratory of claim 11 wherein providing a plurality of test systems comprises providing at least a gas chromatography system and a mass spectroscopy system.

15. The method of providing a mobile laboratory of claim 11 wherein providing a plurality of test systems comprises providing at least a gas chromatography system, a liquid chromatography system, and a mass spectroscopy system.

16. The method of providing a mobile laboratory of claim 11 wherein mounting at least one of the test systems in the vehicle in a suspension platform comprises placing the at least one test system on a floating attachment tray that provides shock absorption.

17. The method of providing a mobile laboratory of claim 16 wherein mounting at least one of the test systems in the vehicle in a suspension platform further comprises attaching the at least one test system to a holding bracket which is supported by a plurality of gimbals.

18. The method of providing a mobile laboratory of claim 11 wherein providing a vehicle comprises providing a self-propelled vehicle.

19. The method of providing a mobile laboratory of claim 11 wherein providing a vehicle comprises providing a trailer.

20. The method of providing a mobile laboratory of claim 11 further comprising securing the suspension platform to a benchtop.
